(19) United States
(12) Patent Application Publication
(10) Pub. No.: US 2017/0167940 A1
(43) Pub. Date: Jun. 15, 2017

(54) Golf club head balancing fulcrum

(71) Applicant: Phillip Lapuz, Carlsbad, CA (US)

(72) Inventor: Phillip Lapuz, Carlsbad, CA (US)

(21) Appl. No.: 14/967,846

(22) Filed: Dec. 14, 2015

(51) Int. Cl. G01M 1/12; A63B 53/00; A63B 60/42

(52) U.S. Cl. CPC G01M 1/122; A63B 60/42; A63B 53/007

(57) ABSTRACT

This invention is directed toward a balancing device that can be used to find the balance center of a golf club head. It is specifically applicable to finding the “sweet spot” of putters. The device comprises a base portion that holds the device in place, and a fulcrum portion, upon which the head is placed and moved back and forth until it is balanced. The section of the golf club directly above the fulcrum is thereby found to be the center of the club, with an even amount of weight distributed on either side of the fulcrum. This allows a golf club manufacturer to accurately place a line on the golf club head that guides the golfer to the ideal portion of a golf club that should strike the ball.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of golf club manufacture, and more specifically, to a balancing device that can be used to find the center of gravity of a golf club head. It is specifically applicable to finding the “sweet spot” of putters. The device comprises a base portion that holds the device in place, and a fulcrum portion, upon which the head is placed and moved back and forth until it is balanced. The section of the golf club directly above the fulcrum is thereby found to be the center of the club, with an even amount of weight distributed on either side of the fulcrum. This allows a golf club manufacturer to accurately place a line on the golf club head that guides the golfer to the ideal portion of a golf club that should strike the ball.

History of the invention's industry. Golf clubs have been used to play golf for around 500 years, but attempts to find the true, balanced center of a golf club have been popular for only the last couple of decades. When a golf club strikes a ball with a portion of the club face other than the true center, the club face will twist in the direction of the off centered area and slightly deflect the ball form its ideal path. So if the ball is stuck toward the heel of the club and the sweet spot is toward the center the face will turn inward toward the heel. Same goes for the toe of the club. And while the deflection may be less than one degree, even half a degree of deflection on a 20′ putt can result in a missed putt. While many golf clubs, particularly putters, have a line on the head indicating where the manufacturer thinks the true center is, in many cases the location is incorrect as the club head was not correctly balanced before the location of the line was selected.

Thus there has existed a long-felt need for a means by which golf club manufacturers—and hobbyist golfers who build their own clubs—can find the true center of a club head, and to do it accurately, easily, and with minimal expense.

The current invention provides just such a solution by having a fulcrum device upon which a golf club head can be placed, and moved back and forth until it balances. The place upon which it balances is the true center of the golf club, and an appropriate location for a line to be placed guiding golfers where to strike the ball.

### SUMMARY OF THE INVENTION

It is a principal object of the invention to provide a simple, inexpensive device that can be used to effectively find the true center of gravity for the head portion of a golf club.

It is another object of the invention to create a device upon which an existing golf club head can be placed to determine whether the line drawn on the head was placed correctly.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a series of views of the invention showing its design from several different angles.

FIG. 2 is a front view of the invention being used to balance the head of a putter.

FIG. 3 is a perspective view of the invention being used to balance the head of a putter.

FIG. 4 is a top view of the invention being used to balance the head of a putter.

FIG. 5 is a side view of the invention being used to balance the head of a putter.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

### REFERENCE NUMBERS

1. Base
2. Fulcrum portion
3. Top
4. Upper Surface
5. Side
6. End
7. Beveled edge
8. Curved transition.
10. Putter Head
11. Invention generally.
12. Direction of tipping
13. Center Line.

Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

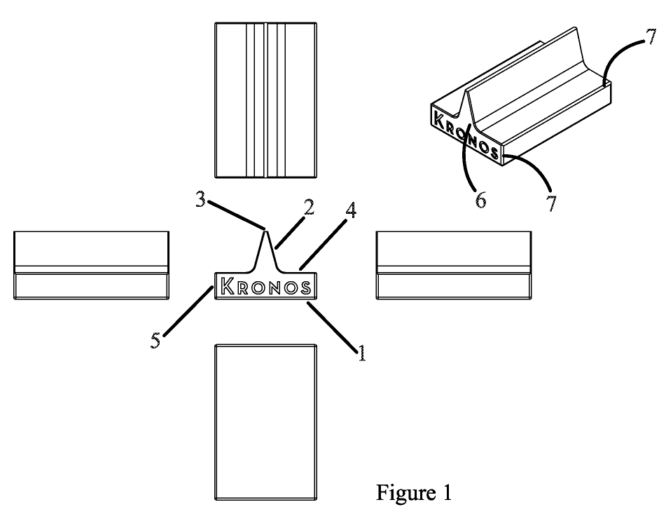

FIG. 1 is a series of views of the invention showing its design from several different angles. The invention has a base portion, two ends 6, two sides 5, an upper surface 4, and a fulcrum portion 2 that extends upward from the upper surface 4. The top 3 of the fulcrum portion is a thin, flattened section. The thin, flattened section on the top 3 can be varied in width depending on the exactness desired in finding the true center of gravity. It is on this top 3 that the golf club head is balanced to find the true center of gravity for the golf club head. The base portion also has, optionally, beveled edges 7 and a curved transition 8 from the upper surface to the fulcrum portion.

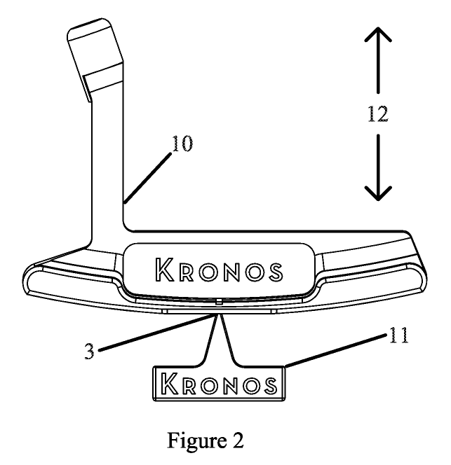

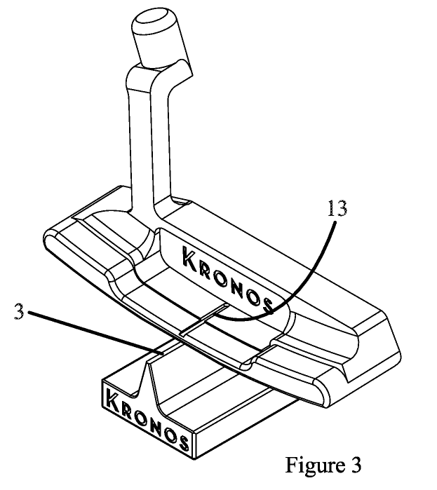

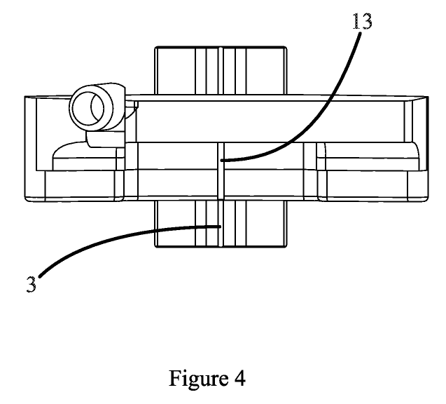

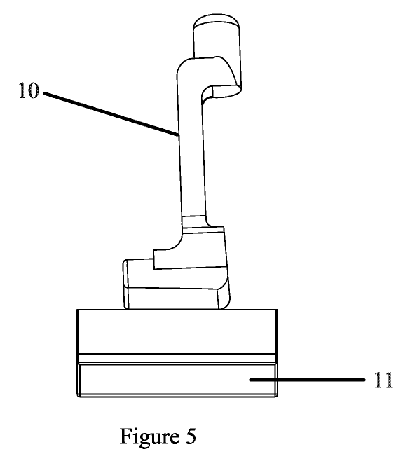

FIGS. 2-5 are a variety of views of the invention being used to balance the head of a putter, with FIG. 2 being a front view, FIG. 3 being a perspective view, FIG. 4 being a top view, and FIG. 5 being a side view. When the golf club head—in this case a putter head 10—is placed on the invention 11, the putter head is moved back and forth until the putter heads rests on the top 3 of the invention without falling to one side or the other, with reference number 12 indication the two possible directions of tipping. Once the balancing point has been found and the club head no longer tips 12 to one side or the other, a manufacturer or hobbyist golf club maker knows where the “sweet spot” is, and can mark a corresponding line 13 of the head, such that when the head is used on a golf course, the user knows exactly what portion of the club should strike the ball. For a manufacturer, the center line 13 can be inscribed into the mold such that each head that leaves the mold has the correct sweet spot designated on the head and clearly visible to the golfer who uses that club. For the hobbyist, he or she can easily put a thin strip of tape, or even paint a line to accomplish the same goal.

FIG. 2 also illustrates how the owner of an existing golf club can removed the head and place is on the fulcrum to determine whether the “center line” was correctly placed. As mentioned in the discussion under FIG. 1, the width of the top of the fulcrum can vary in different versions of the invention, such that a company desiring a very exact determination of the where the center line should go could select a wedge with a very narrow top, while a class teaching elementary school students how to find the center of a club head they made in class could have a considerably wider (and therefore more easy to use) top.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A device for finding the true center of gravity for a golf club putter head, comprising a base portion, where the base portion comprises a base, where the base comprises a flat bottom with a base length and a base width, a fulcrum portion, where the fulcrum portion additionally comprises a top, two sides, two ends, and an upper surface, where the fulcrum portion when viewed from one of the two ends is a triangle, and where the fulcrum portion extends vertically from the base portion, and where the top is a relatively thin, flattened section at that portion of the fulcrum portion extending highest into the air, and where the top has a top length and a top width, where the length is equal to the base length, and the top width is less than 1 mm.

2. The device of claim 1, where the top width is 0.66 mm.

3. The device of claim 2, additionally comprising at least one beveled edge.

4. The device of claim 3, additionally comprising at least one curved transition, where the curved transition is a portion of the device that has a beginning and an end, where the beginning is an upper surface and the end is the fulcrum portion.

5. A device for finding the true center of gravity for a golf club putter head, comprising a base portion, where the base portion comprises a base, where the base comprises a flat bottom with a base length and a base width, a fulcrum portion, where the fulcrum portion additionally comprises a top, two sides, two ends, and an upper surface, where the fulcrum portion when viewed from one of the two ends is a triangle, and where the fulcrum portion extends vertically from the base portion, and where the top is a relatively thin, flattened section at that portion of the fulcrum portion extending highest into the air, and where the top has a top length and a top width, where the length is equal to the base length.

6. The device of claim 5, where the golf club head is a putter head.

7. The device of claim 5, where the fulcrum portion when viewed from a side view is a triangle.

8. The device of claim 7, where the top width is less than 1 mm in width.

9. The device of claim 8, where the top width is 0.66 mm.

10. The device of claim 9, additionally comprising at least four beveled edges.

11. The device of claim 10, additionally comprising at least one curved transition, where the curved transition is a portion of the device that has a beginning and an end, where the beginning is an upper surface and the end is the fulcrum portion.

12. The device of claim 7, where the top is less than 2 mm in width.

13. The device of claim 7, where the top is less than 3 mm in width.

14. The device of claim 3, where the fulcrum portion when viewed from a side view is a triangle section on top of a trapezoidal section with a base attachment section that is wider than an upper section, and where the roughly triangular section is attached to the upper section.

15. The device of claim 3, where the fulcrum portion when viewed from a side view has a curve in it.

16. The device of claim 1, where the top is less than 1 mm in width.

17. The device of claim 8, where the top width is 0.66 mm.

18. The device of claim 9, additionally comprising at least eight beveled edges.

19. The device of claim 10, additionally comprising at least one curved transition, where the curved transition is a portion of the device that has a beginning and an end, where the beginning is an upper surface and the end is the fulcrum portion.

20. A device for finding the true center of gravity for a golf club putter head, consisting of a base portion, where the base portion comprises a base, where the base comprises a flat bottom with a base length and a base width, a fulcrum portion, where the fulcrum portion additionally comprises a top, two sides, two ends, and an upper surface, where the fulcrum portion when viewed from one of the two ends is a triangle, and where the fulcrum portion extends vertically from the base portion, and where the top is a relatively thin, flattened section at that portion of the fulcrum portion extending highest into the air, and where the top has a top length and a top width, where the length is equal to the base length, and the top width is less than 1 mm, additionally comprising at least one beveled edge, and additionally comprising at least two curved transitions, where the at least two curved transitions are a portion of the device that has a beginning and an end, where the beginning is an upper surface and the end is the fulcrum portion.
